(19) United States
(12) Patent Application Publication
(10) Pub. No.: US 2013/0062438 A1
(43) Pub. Date: Mar. 14, 2013

(54) LIQUID DISTRIBUTOR

(71) Applicants: Pascal Ueberschlag, Fislis (FR); Armin Dreher, Maulburg (DE); Frank Maurer, Inzlingen (DE)

(72) Inventors: Pascal Ueberschlag, Fislis (FR); Armin Dreher, Maulburg (DE); Frank Maurer, Inzlingen (DE)

(21) Appl. No.: 13/580,702

(22) PCT Filed: Feb. 23, 2011
(86) PCT No.: PCT/EP2011/052692

§ 371 Date: Sep. 13, 2012

(30) Foreign Application Priority Data
Feb. 25, 2010 (CH) 00234/10

(51) Int. Cl. B05B 1/14

(52) U.S. Cl. 239/548

(57) ABSTRACT

The invention relates to a device for distributing liquids comprising a distribution chamber (12) having a liquid inlet (3) and a plurality of liquid outlets (7). Protrusions (19, 20) extend into the distribution chamber (12) between the liquid outlets (7) and thus prevent dead spaces in which sediments can settle.

The invention relates to a device for distributing liquids, comprising a distribution chamber, a liquid inlet arranged on a side of the distribution chamber, and a plurality of liquid outlets arranged on the opposing side.

Distributing a liquid flow into a plurality of outgoing partial flows takes place in many different applications. Devices for such a distribution are often constructed such that a line conducting the liquid flow to be distributed leads into a chamber from which the lines extend which conduct the partial flows. Thus, most common is a flat-cylindrical form, wherein the liquid inlet is arranged on a flat side of the chamber and the liquid outlets are arranged distributed on the opposing side.

It was found that problems can occur when using such distribution devices for distributing suspensions. The flow conditions in the chamber are such that along the direct connection lines from the liquid inlet to the outlets, the strongest flow occurs, while between these strong flows, there are regions with only little liquid movement. In these dead spaces, segregation of the suspension and deposition of solids takes place. This often results in malfunctions during the operation, especially if parts of the deposited materials come off in the form of rather large sediment pieces and get into the outlet lines.

It is therefore an object of the invention to find a distribution device which is primarily suitable for suspensions and with which the mentioned problems can be avoided.

According to the invention, this is achieved in that between the liquid outlets, projections protrude into the chamber.

According to a preferred embodiment, these projections are substantially triangular and are directed with a tip toward the center of the chamber. According to a further preferred embodiment, this is achieved through an insert which is inserted into a flat-cylindrical chamber and has a cylindrical outer wall and a star-shaped recess.

Preferred exemplary embodiments of the invention are described hereinafter by means of the enclosed drawings.

In the figures

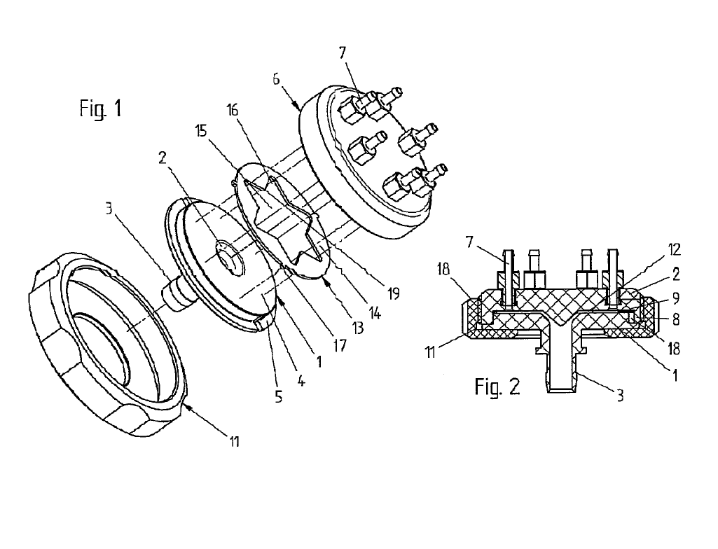

FIG. 1 shows an exploded illustration of a distributor for suspensions.

FIG. 2 shows a section through the assembled distributor.

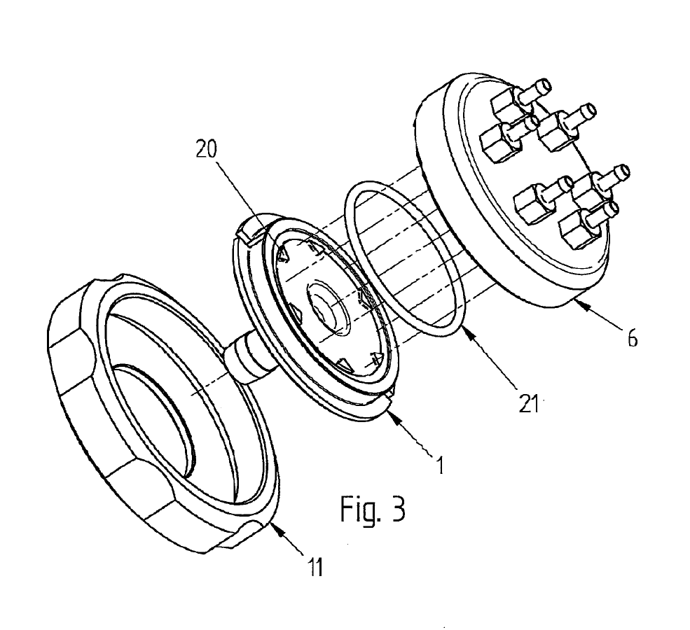

FIG. 3 shows an exploded illustration of another embodiment of the distributor.

The distributor shown in FIG. 1 consists of an inlet-side cylindrical plate 1, in the center of which a liquid inlet 2 in the form of a tube connection 3 is arranged, and an outlet-side plate 6 with liquid outlets in the form of tube connections 7 arranged distributed at uniform angular distances. The present exemplary embodiment has six outlets. However, less outlets, i.e., three to five outlets, or also more than six outlets are readily possible.

As shown in FIG. 2, the outlet-side plate 6 has a circumferential projecting edge 8 defining a cylindrical deepening 9. The inlet-side plate 1 has an inner part 4 facing toward the outlet-side plate, and a flange-shaped outer part 5. The diameter of the inner part 4 corresponds to the inner diameter of the deepening 9 so that in the assembled state, the inner part 4 is located in the deepening 9 and the flange-shaped part rests against the edge 8.

In the assembled state, the two plates are held together by a cap nut 11 which engages in a thread on the outer side of the outlet-side plate. The two plates are dimensioned such that in the assembled state, a flat-cylindrical intermediate space 12 is created therebetween which forms a distribution chamber as shown in FIG. 2 on the right side, where the chamber is shown empty for clarification purposes.

An insert 13 which has a cylindrical outer wall 14 and a star-shaped recess 15 is inserted in said intermediate space 12. The insert is preferably made from an elastic material, for example from PTFE, silicone, etc., and provides at the same time for the sealing function between the plates. The number of the outwardly directed tips 16 of the recess corresponds to the number of the outlets. The insert has positioning cams 17 which engage in corresponding grooves 18 in the wall of the deepening in such a manner that the tips of the recess are positioned in each case at an outlet. In this manner, the space between the outlets is filled by the triangular projections 19 between the tips, i.e., there is no longer a dead space in which depositing of solids can take place.

The embodiment shown in FIG. 3 is structured in the same manner as the distributor shown in FIGS. 1 and 2, comprising an inlet-side plate 1, an outlet-side plate 6 and a cap nut 11; however, with the difference that no insert is provided, but triangular projections 20 are integrally formed on the front end of the inlet-side plate 1. For sealing between the plates, an O-ring 21 is provided.

The embodiment shown in FIGS. 1 and 2 is suitable specifically for retrofitting existing distributors. Moreover, this embodiment is particularly flexible in that by exchanging the insert, it is possible here to change the number of outlets.

1. A device for distributing liquids, comprising a flat-cylindrical distribution chamber arranged between two circular plates, a liquid inlet arranged on one of the plates bordering the distribution chamber, and a plurality of liquid outlets arranged on the opposing plate, characterized in that between the liquid outlets, projections narrowing radially inward protrude into the distribution chamber, said projections bordering the distribution chamber in a substantially star-shaped manner.

2. The distribution device according to claim 1, characterized in that the projections are substantially triangular and are directed with a tip toward the center of the distribution chamber.

3. The distribution device according to claim 1, characterized by an insert inserted into the distribution chamber, said insert having a cylindrical outer wall and a star-shaped recess.
